(19) United States
(12) Patent Application Publication
(10) Pub. No.: US 2003/0168036 A1
(43) Pub. Date: Sep. 11, 2003

(54) Method and device for regulating an operating variable of an internal combustion engine

(76) Inventors: Mario Kustosch, Markgroeningen (DE); Christian Koehler, Erligheim (DE)

Correspondence Address: Walter Ottesen, Patent Attorney, P O Box 4026, Gaithersburg, MD, 20885-4026, US

(21) Appl. No.: 10/344,257

(22) PCT Filed: Jul. 20, 2001
(86) PCT No.: PCT/DE01/02745

(30) Foreign Application Priority Data
Aug. 10, 2000 (DE) 100 38 991.0

(51) Int. Cl. F02B 17/00; F02D 43/00

(52) U.S. Cl. 123/295; 123/339.12; 123/352

(57) ABSTRACT

A method and an arrangement for controlling an operating variable of an internal combustion engine are suggested. A controller is provided which, in dependence upon a control deviation, generates an output signal for controlling the operating variable with this output signal being generated in accordance with at least one changing parameter. In dependence upon the operating mode (stratified operation, homogeneous operation, homogeneous lean operation), the value of this at least one parameter is switched over to values adapted specifically to the path in the particular mode of operation.

### STATE OF THE ART

The invention relates to a method and an arrangement for controlling an operating variable of an internal combustion engine.

In many cases, control systems are utilized in modern control systems for internal combustion engines of motor vehicles. These control systems control an operating variable of the engine and/or of the vehicle to a pregiven desired value. An example of such control systems are idle rpm controllers via which the rpm is controlled to a pregiven desired value during idle of the engine. Other examples are control systems for controlling: the air throughput through the engine, the exhaust-gas composition, the torque, et cetera. DE 30 39 435 A1 (U.S. Pat. No. 4,441,471) discloses an idle rpm control system wherein at least one parameter of the controller is to be configured to be variable for improving the control characteristics. In the embodiment shown, the proportional component of the controller is adapted to the control deviation in dependence upon the operating variable.

In internal combustion engines having gasoline direct injection, the dynamic performance of the engine differs in dependence upon the instantaneous mode of operation, that is, for example in stratified charge operation, in homogeneous lean operation or in homogeneous operation. The known controller is not adapted to a change of this kind of the dynamic performance of the control path.

### ADVANTAGES OF THE INVENTION

With the use of at least one operating-mode dependent parameter of the controller, an improved adaptation of the controller to the control path and its changes is achieved, especially in the dynamic performance.

For each operating mode of an internal combustion engine having gasoline direct injection, an optimal quality with respect to rapidity and stability of the control is obtained. The optimal control quality is adapted to this operating mode in each case.

Further advantages will become apparent from the following description of the embodiments and/or from the dependent patent claims.

### DRAWING

The invention will be explained hereinafter in greater detail with respect to the embodiments shown in the drawing.

FIG. 1 shows an overview circuit diagram of a controller for an operating variable of an internal combustion engine with respect to example of an idle rpm controller; while,

FIG. 2 shows a sequence diagram which presents a preferred embodiment of the controller for which at least one parameter is changed in dependence upon the instantaneous operating mode.

### DESCRIPTION OF THE EMBODIMENTS

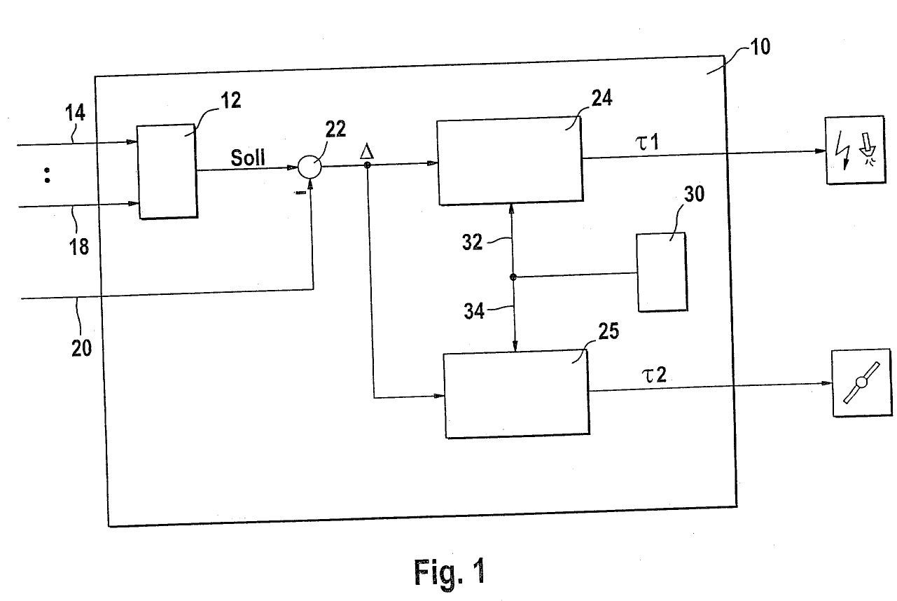

FIG. 1 shows an electronic control unit 10 for controlling an internal combustion engine which includes a computer unit (not shown) wherein a control of at least one operating variable is implemented. In the preferred embodiment, the control is an idle rpm control. In other embodiments, the control can be an air throughput control, a load control, a torque control, a control for the exhaust-gas composition, the road speed, et cetera. The corresponding desired and actual values as well as drive signals are to be utilized. In FIG. 1, a desired value former 12 is shown which forms a desired value Soll for the operating variable to be controlled in dependence upon at least one operating variable supplied via the input lines 14 to 18 of the control unit 10. In the preferred embodiment of an idle rpm controller, the variables, which are applied for forming the desired value, are the engine temperature, the operating status of ancillary consumers such as a climate control system, et cetera. Furthermore, a signal is supplied to the control unit 10 via the input line 20 which defines the actual quantity of the operating variable to be controlled. Desired and actual variables are compared to each other in the comparator 22. The deviation between desired and actual variables is supplied to the controllers 24 and 25 as a control deviation Δ. At least one of these controllers 24 and 25 includes at least one changing parameter. In the preferred embodiment, at least one of these controllers comprises a proportional component, differential component and integral component. Depending upon the embodiment, each of the components or only one or several of the components are changeable in dependence upon operating variables as well as in the sense of a switchover dependent upon the operating mode of the internal combustion engine.

The controller 24 forms at least one output signal τ1 on the basis of the implemented control strategy and in dependence upon the control deviation Δ. This output signal τ1 influences at least one of the control variables of the internal combustion engine by means of which a rapid torque change of the engine is effected. These operating variables are ignition angles and/or metered fuel. In homogeneous operation, the ignition angle is influenced and outside of the homogeneous operation, the fuel quantity is influenced. The second controller 25 forms at least one further output signal τ2 likewise in dependence upon the control deviation Δ in accordance with the implemented control strategy (preferably, PD structure). The additional output signal τ2 influences at least a control variable which leads to a comparatively slow adjustment of the torque. In an internal combustion engine, this control quantity is the air supply so that the drive signal τ2 drives an actuating member, for example, a throttle flap for influencing the air supply to the engine. In the illustrated embodiment, each component of the controller 24 or of the controller 25 forms a controller output signal which together (for example, added) form the particular output signal τ1 or τ2.

The various components of the controller 24 and/or of the controller 25 have parameters such as amplification factors whose value can be changed as required in dependence upon the embodiment, that is, they can be switched over between at least two values or characteristic lines.

In the preferred embodiment of an idle control, as a rule, a controller having a proportional component, integral component and differential component is utilized. In the operating mode “homogeneous operation”, the internal combustion engine is operated with a stoichiometric mixture and, in this operating mode, proportional and differential components are configured in duplicate. One controller functions for shifting the ignition angle and the other controller for adjusting the charge (air supply). In the stratified operation or in homogeneous lean operation, an adjustment of the engine torque is possible only via the fuel quantity but not via the air quantity. In these operating modes, the dynamic performance of the engine therefore differs from the dynamic performance in the homogeneous operation. The time point of the torque determining intervention with reference to the top dead center of the cylinder lies elsewhere in these operating modes. In this way, there is another dead time of the control path. Furthermore, a large torque change can be realized significantly faster by changing the fuel quantity than in homogeneous operation.

At least one parameter of the controller 24 and/or the controller 25 is switched over between different values (individual values or characteristic lines) in dependence upon an operating mode signal. This operating mode signal is generated in dependence upon the instantaneous operating mode in 30 and is supplied to the corresponding controllers for switchover via the lines 32 and 34, respectively. The parameter values consider the optimal adaptation of the controller to the changing path dynamic. In this connection, the idle controller is better adapted to the path dynamic while utilizing operating-mode dependent parameter sets. In addition to the switchover of the parameter values in dependence upon the operating mode, in one embodiment, all parameter values are additionally functions of the control deviation.

If a switchover of the operating mode of the engine takes place from homogeneous operation into one of the other operating modes, then the controller 25, which defines the air component, is switched off, for example, in that its controller output signal or its parameter values are set to 0. Furthermore, the controller parameter values of the controller 24 are set via the switching signal to the values adapted to the new operating mode. In the preferred embodiment, the controller parameter values are of the proportional component, the integral component and the differential component. Primarily, stratified operation and homogeneous lean operation are to be considered as operating modes. One operates correspondingly when switching over between stratified operation and homogeneous lean operation. Here too, a parameter value switchover is undertaken in the controller 24. The controller 25 remains switched off for the slow intervention. For a switchover from homogeneous lean operation or from stratified operation into homogeneous operation, a parameter value switchover in controller 24 likewise takes place; while, when the corresponding activation signal is present, the controller 25 for the slow component is activated in homogeneous operation. In the preferred embodiment, the activation or switch-off of the controller 25 takes place via setting its output signal to the value 0. The controller itself then continues to operate in this embodiment also in other operating modes but its output signal is not effective externally.

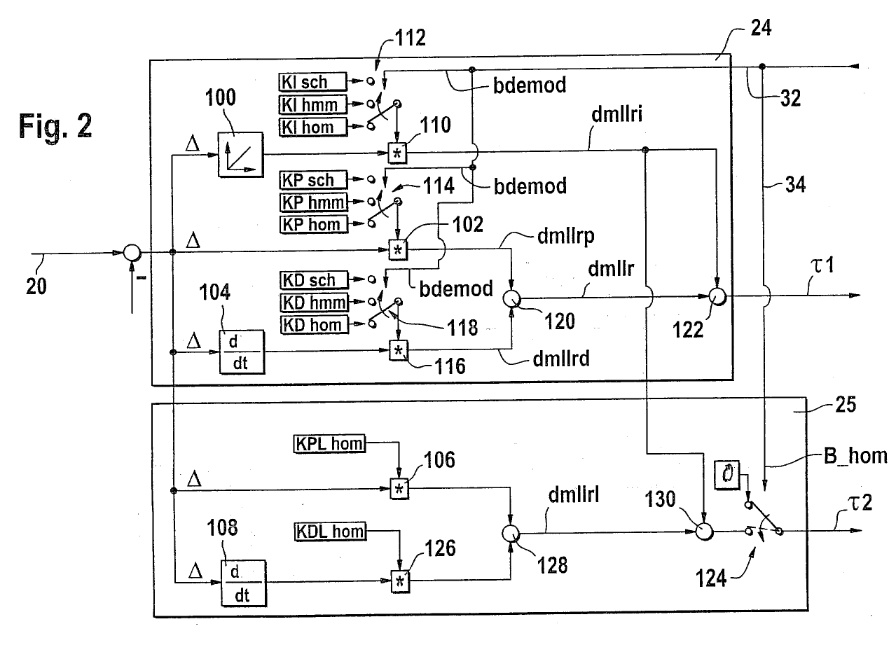

A preferred embodiment of the described procedure is outlined based on the sequence diagram of FIG. 2 which shows a program of the computer unit of the control unit 10. The sequence diagram shows special configurations of the controllers 24 and 25.

The control deviation Δ is supplied to the controllers as a deviation between actual and desired values (actual and desired rotational speeds). In the controller 24, the following are provided for the rapid intervention path: an integrator 100, an amplifier stage 102 and a differential stage 104; whereas, in the preferred embodiment, the following are provided in the controller 25 for the slow path: an amplifier stage 106 and a differential stage 108. In other embodiments, other configurations of the controllers are utilized so that the control strategy shown defines only a preferred embodiment for each case. The described procedure of the switchover of parameter values is also used in other controller structures having the corresponding advantages in dependence upon the operating mode of the internal combustion engine.

The idle controller shown in FIG. 2 is better adapted to the path dynamic when utilizing operating-mode dependent parameter sets. The control deviation Δ is preferably computed via subtraction of the desired rpm Soll from the

engine actual rpm IST. The output signal DMLLRI of the integral component 100 is formed by integrating the control deviation Δ over time in the integrator 100 with subsequent amplification (multiplication) in the amplifier stage 110. In the amplifier stage 110, the integrator output signal is multiplied by the parameter KI which can assume different values in dependence upon the instantaneous operating mode. Switching means 112 is provided for selecting the parameter values and this switching means 112 is switched over in dependence upon operating-mode signal BDEMOD supplied via the line 32. The signal BDEMOD contains information as to the instantaneous mode of operation of the internal combustion engine. The multiplication in stratified operation takes place with a factor KISCH and takes place in homogeneous operation with a factor KIHMM and in homogeneous operation with a factor KIHOM. These factors are adapted especially to the dynamic performance of the control path in the particular operating mode. It has been shown that in stratified operation, as a rule, smaller values are to be inputted than in homogeneous operation. This applies correspondingly also for the other components of the controller 24. In dependence upon the embodiment, the above-mentioned values are either fixed values or pregiven values from characteristic lines with the values being dependent upon operating variables.

In the preferred embodiment, a proportional component is present in addition to the integral component. The output signal DMLLRP of the proportional component is formed in the amplifier stage 102 by logic coupling (multiplication) of the control deviation Δ with a proportional amplification factor KP. This factor too exhibits different values depending upon the operating mode. This selection takes place by means of switching means 114 in accordance with the operating-mode signal BDEMOD. Here too, one or several first parameter values KPSCH are selected in stratified operation. In homogeneous lean operation one or several values KPHMM are selected and, in homogeneous operation, third values KPHOM are selected.

The differential component of the controller 24 is formed by time differentiation of the control deviation Δ in the differentiator 104 and subsequent logic coupling (multiplication) of the result of the differentiation in the amplifier stage 116. There, the logic coupling of the result of the differentiation stage 104 takes place with a pregiven parameter KD which, depending upon the instantaneous operating mode, can assume different values. Here too, the selection takes place by means of switching means 118 in dependence upon the above-mentioned operating-mode signal BDEMOD. Accordingly, in stratified operation, a parameter value KDSCH is supplied to the multiplication and in homogeneous lean operation, a value KDHMM is supplied and in homogeneous operation a value KDHOM is supplied. In an addition position 120, the output signal DMLLRD is combined with the output signal DMLLRP of the proportional component to the controller output signal DMLLR. In the following addition position 122, this control output signal is superposed onto the output signal DMLLRI of the integral component. The output signal of the stage 122 forms the drive signal τ1 via which a shift of the ignition angle takes place in homogeneous operation and, in the operating modes “stratified operation” and “homogeneous lean operation”, an adjustment of the fuel mass to be injected takes place. The drive signal τ1 operates on the so-called fast path because, with the intervention possibilities shown, a rapid change of the torque of the internal combustion engine is possible.

As shown above, the controller 25 serves the slow path, namely the intervention on the supplied air quantity. This path is only used in homogeneous operation to adjust the torque; whereas, in the lean operating modes, such as stratified operation or homogeneous lean operation, one profits from the consumption advantage by dethrottling the engine. For this reason, a switching element 124 is provided which switches over from the position shown into its second position and thereby switches the controller 25 so that it is effective externally when the operating mode “homogeneous operation” is set. A corresponding switching signal is supplied via the line 34. In all other operating modes, the switching element 124 assumes the position shown so that the value 0 is present as the output signal τ2 of the controller 25. The formation of the controller output signal DMLLRL (that is, τ2 of the controller 25) takes place in the amplification stage 106 via multiplication of the control deviation Δ by a factor KPLHOM for the homogeneous operation. Correspondingly, the control deviation Δ is differentiated in the differentiation stage 108 and, thereafter, is multiplied by the factor KDLHOM in the multiplication stage 126. The output signals of the proportional and differential components are combined to the controller output signal DMLLRL in the logic position 128. The output signal DMLLRI of the integral component (100, 110) is superposed on the controller output signal DMLLRL in the addition position 130. The output signal of the logic position 130 defines the output signal τ2 of the controller 25 which, as mentioned above, is effective externally only in the operating mode “homogeneous operation”.

The individual parameter values for the individual operating modes are adapted to the specific requirements of the specific control path. Experience has shown that in many cases, smaller values are to be inputted in stratified operation than in other operating modes.

In lieu of the specific configuration of the controllers shown in FIG. 2, another control strategy can be utilized in other embodiments, for example, the differential components can be omitted depending upon the embodiment.

1. Method for controlling an operating variable of an internal combustion engine wherein there is a switchover during operation of the engine between at least two operating modes, at least one controller output signal being formed in accordance with at least one changing parameter in dependence upon the deviation between desired and actual values for the operating variable, the operating variable to be controlled being influenced by the controller output signal, characterized in that a switchover of the value of the at least one parameter is undertaken for a change of the operating mode of the internal combustion engine.

2. Method of one of the above claims, characterized in that the internal combustion engine is an internal combustion engine having gasoline-direct injection wherein there is a switchover between the operating modes “stratified operation”, “homogeneous lean operation” and “homogeneous operation” with throttling.

3. Method of one of the above claims, characterized in that the controller output signal influences the ignition angle in the operating mode “homogeneous operation” and influences the fuel supply in unthrottled modes of operation.

4. Method of one of the above claims, characterized in that the controller includes an integral component and/or a proportional component and/or a differential component.

5. Method of claim 4, characterized in that the value of the at least one parameter is switched over to values, which are adapted to the path behavior in the special operating mode, the switchover being dependent upon a signal which represents the instantaneous operating mode.

6. Method of one of the above claims, characterized in that the output signal influences the air supply to the internal combustion engine in the throttled operation and the output signal is switched to be ineffective outside of the throttled operation of the internal combustion engine.

7. Method of one of the above claims, characterized in that the at least one parameter is further dependent upon the control deviation.

8. Method of one of the above claims, characterized in that the values of the at least one parameter are fixed values, which are dependent upon the mode of operation, or are operating-variable dependent values which are formed from characteristic lines selected in accordance with the mode of operation.

9. Method of one of the above claims, characterized in that the controller is an idle rpm controller or a road speed controller.

10. Arrangement for controlling an operating variable of an internal combustion engine wherein there is a switchover between at least two operating modes during operation of the engine, the arrangement having a controller which forms at least one controller output signal in accordance with at least one changing parameter in dependence upon the deviation between a desired value and an actual value for the operating variable, the output signal influencing the operating variable, characterized in that the controller further receives a signal characterizing the instantaneous operating mode and, in dependence upon this signal, a switchover is undertaken of the value of the at least one parameter.
